(19) United States
(12) Patent Application Publication
(10) Pub. No.: US 2011/0227001 A1
(43) Pub. Date: Sep. 22, 2011

(54) ELECTRODE MATERIAL AND USE THEREOF FOR PRODUCTION OF ELECTROCHEMICAL CELLS

(75) Inventors: Martin Schulz-Dobrick, Mannheim (DE); Martin Lerch, Berlin (DE); Helmut Ehrenberg, Darmstadt (DE); Suliman Nakhal, Berlin (DE); Julia Koch, Berlin (DE); Frieder Scheiba, Dresden (DE); Markus Herklotz, Dresden (DE)

(73) Assignee: BASF SE, Ludwigshafen (DE)

(21) Appl. No.: 13/051,145

(22) Filed: Mar. 18, 2011

Related U.S. Application Data
(60) Provisional application No. 61/315,444, filed on Mar. 19, 2010.

(51) Int. Cl. H01B 1/18; H01M 4/485; H01M 4/58; B82Y 30/00

(52) U.S. Cl. 252/507; 252/182.1; 252/508; 252/506; 977/742; 977/734

(57) ABSTRACT

An electrode material comprising at least one compound of the general formula (I)

LiₐM_{b}F_{c}O_{d} (I)

in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0.

The present invention relates to an electrode material comprising at least one compound of the general formula (I)

LiₐM_{b}F_{c}O_{d} (I)

in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0.

The present invention further relates to electrodes which comprise at least one inventive electrode material. The present invention further relates to electrochemical cells which comprise at least one inventive electrode.

Electrochemical cells which have a high storage capacity coupled with maximum operating voltage are of increasing significance. The desired capacities generally cannot be achieved with electrochemical cells which work on the basis of aqueous systems.

In lithium ion batteries, charge transfer is ensured not by protons in more or less hydrated form, but rather by lithium ions in a nonaqueous solvent or in a nonaqueous solvent system. A particular role is assumed by the electrode material.

Many electrode materials known from the literature are mixed oxides of lithium and one or more transition metals; see, for example, US 2003/0087154. In the charged state of the battery, such materials tend to decompose and to react with the electrolyte system, such that the maximum charging voltage is limited in many cases. This limit has an adverse effect on the achievable energy density of the battery. A high energy density of the battery is generally advantageous, especially for mobile applications.

Accordingly, the electrode materials defined at the outset have been found, which are also referred to in the context of the present invention as inventive electrode materials.

Inventive electrode materials comprise at least one compound of the general formula (I)

LiₐM_{b}F_{c}O_{d} (I)

in which the variables are each defined as follows:
M is at least one transition metal selected from Ti, Cr, V and Mn, preferably Mn and V and more preferably V. Mixtures of the aforementioned transition metals are also suitable, for example V/Mn mixtures or V/Cr mixtures.

It is possible for Ti, Cr, V or Mn to be replaced partially by Al, Ga, Ni, Fe or Co, for example in the range from 0.01 up to 45 mol %, preferably up to 10 mol % and more preferably up to 2 mol %, based in each case on the total content of M. Preferred metals by which replacement is possible are selected from Fe, Co and Ni.

In one embodiment of the present invention, Ti, Cr, V or Mn is partially replaced by at least two of the metals Al, Ga, Ni, Fe or Co.

Proportions of less than 0.05 mol %, based on total content of M, are not considered to be replacement of M in the context of the present invention.

In one embodiment of the present invention, Ti, Cr, V or Mn is replaced neither by Al nor by Ga, Ni, Fe or Co.

a is in the range from 2.5 to 3.5, preferably 2.8 to 3.2,
b is in the range from 0.8 to 1.2,
c is in the range from 5.0 to 6.5, preferably 5.8 to 6.2, and
d is in the range from zero to 1.0, preferably to 0.3, more preferably zero.

In one embodiment of the present invention, the formal oxidation state of M is +3.

In the cases in which d is not zero, the mean oxidation state of M may be greater than +3.

In another embodiment of the present invention, in which d is zero, the mean oxidation state of M is +3, and a corresponding number of sites in the crystal lattice remain unoccupied.

In one embodiment of the present invention, Li is replaced to an extent of up to 10 mol % by sodium, zinc or magnesium, for example in the range from 0.01 to 10 mol %, preferably 1 to 5 mol %.

In one embodiment of the present invention, in which Li is replaced to an extent of up to 10 mol % by Na, Zn or Mg, the oxidation state of M is +3, and a corresponding number of sites in the crystal lattice remain unoccupied.

In another embodiment of the present invention, Li is replaced to an extent of up to 10 mol % by Na, Zn or Mg, and correspondingly—in the case of substitution by Zn or Mg—F is replaced by oxygen.

In another embodiment of the present invention, Li is substituted neither by sodium nor by zinc or magnesium.

Proportions of less than 0.05 mol %, based on total content of Li, are not considered to be replacement of Li in the context of the present invention.

In a preferred embodiment of the present invention, a=3, b=1, c=6 and d=zero.

In another preferred embodiment of the present invention, 3<a≦3.5 and 6<c≦6.5 and d=zero, where the difference of a and 3 is equal to the difference of c and 6:

a−3=c−6

In one embodiment of the present invention, F is replaced in certain proportions by oxygen, i.e. 0<d≦1.0, without replacement of Li by Zn or Mg. In such embodiments, the oxidation state of M may be greater than +3.

Compounds of the general formula (I) may be present in various polymorphs, for example as the a polymorph or as the β polymorph.

In general, the a polymorph of compound of the general formula (I) has an orthorhombic crystal lattice.

In general, the β polymorph of compound of the general formula (I) has a monoclinic crystal lattice.

The structure of the particular crystal lattice can be determined by methods known per se, for example X-ray diffraction or electron diffraction.

In one embodiment of the present invention, compound of the general formula (I) is in the form of an amorphous powder. In another embodiment of the present invention, compound of the general formula (I) is in the form of crystalline powder.

In one embodiment of the present invention, compound of the general formula (I) is in the form of particles having a mean diameter (number average) in the range from 10 nm to 200 μm, preferably 20 nm to 30 μm, measured by evaluation of electron micrographs.

The preparation of compounds of the general formula Li₃MF₆ is known per se; see, for example, W. Massa, Z Kristallogr. 1980, 153, 201, A. K. Tyagi et al., Z. Anorg. Allg. Chem. 1996, 622, 1329, A. H. Nielsen, Z. Anorg. Allg. Chem. 1935, 224, 84.

In one embodiment of the present invention, the compound of the general formula (I) is present in inventive electrode material as a composite with electrically conductive, carbonaceous material. For example, compound of the general formula (I) in inventive electrode material may be treated, for example coated, with electrically conductive, carbonaceous material. Such composites likewise form part of the subject matter of the present invention.

Electrically conductive, carbonaceous material can be selected, for example, from graphite, carbon black, carbon nanotubes, graphene or mixtures of at least two of the aforementioned substances. In the context of the present invention, electrically conductive, carbonaceous material can also be referred to as carbon (B) for short.

In one embodiment of the present invention, electrically conductive, carbonaceous material is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, electrically conductive, carbonaceous material is partially oxidized carbon black.

In one embodiment of the present invention, electrically conductive, carbonaceous material comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al. in Chemie lngenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes can be prepared by processes known per se. For example, a volatile carbon compound, for example methane or carbon monoxide, acetylene or ethylene, or a mixture of volatile carbon compounds, for example synthesis gas, can be decomposed in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon-containing compounds in a light arc, specifically in the presence or absence of a decomposition catalyst.

In one embodiment, the decomposition of volatile carbon-containing compound or carbon-containing compounds is performed in the presence of a decomposition catalyst, for example Fe, Co or preferably Ni.

In the context of the present invention, graphene is understood to mean almost ideally or ideally two-dimensional hexagonal carbon crystals with a structure analogous to single graphite layers.

In one embodiment of the present invention, the weight ratio of compound of the general formula (I) and electrically conductive, carbonaceous material is in the range from 200:1 to 5:1, preferably 100:1 to 10:1.

A further aspect of the present invention is an electrode comprising at least one compound of the general formula (I), at least one electrically conductive, carbonaceous material and at least one binder.

Compound of the general formula (I) and electrically conductive, carbonaceous material have been described above.

Suitable binders are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binder is selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In one embodiment, in inventive electrodes, electrically conductive, carbonaceous material is selected from graphite, carbon black, carbon nanotubes, graphene or mixtures of at least two of the aforementioned substances.

In one embodiment of the present invention, inventive electrode material comprises: in the range from 60 to 98% by weight, preferably 70 to 96% by weight, of compound of the general formula (I),

in the range from 1 to 20% by weight, preferably 2 to 15% by weight, of binder,
in the range from 1 to 25% by weight, preferably 2 to 20% by weight, of electrically conductive, carbonaceous material.

The geometry of inventive electrodes can be selected within wide limits. It is preferred to configure inventive electrodes in thin layers, for example with a thickness in the range from 10 μm to 250 μm, preferably 20 to 130 μm.

In one embodiment of the present invention, inventive electrodes comprise a foil, for example a metal foil, especially an aluminum foil, or a polymer film, for example a polyester film, which may be untreated or siliconized.

The present invention further provides for the use of inventive electrode materials or inventive electrodes in electrochemical cells. The present invention further provides a process for producing electrochemical cells using inventive electrode material or inventive electrodes. The present invention further provides electrochemical cells comprising at least one inventive electrode material or at least one inventive electrode.

By definition, inventive electrodes in inventive electrochemical cells serve as cathodes. Inventive electrochemical cells comprise a counter-electrode, which is defined as the anode in the context of the present invention, and which may, for example, be a carbon anode, especially a graphite anode, a lithium anode, a silicon anode or a lithium titanate anode.

Inventive electrochemical cells may, for example, be batteries or accumulators.

Inventive electrochemical cells may comprise, in addition to the anode and inventive electrode, further constituents, for example conductive salt, nonaqueous solvent, separator, output conductor, for example made from a metal or an alloy, and also cable connections and housing.

In one embodiment of the present invention, inventive electrical cells comprise at least one nonaqueous solvent which may be liquid or solid at room temperature, preferably selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (II) and (III)

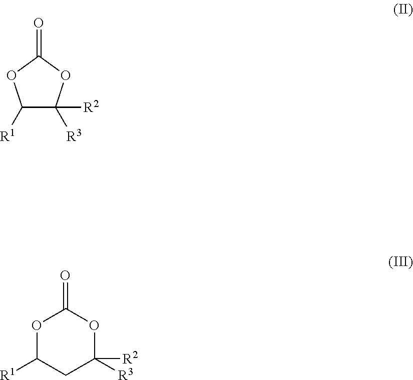

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

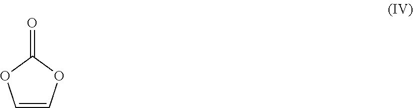

The solvent(s) is (are) preferably used in what is known as the anhydrous state, i.e. with a water content in the range from 1 ppm to 0.1% by weight, determinable, for example, by Karl Fischer titration.

Inventive electrochemical cells further comprise one or more conductive salts. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

In one embodiment of the present invention, inventive electrochemical cells comprise one or more separators by which the electrodes are mechanically separated. Suitable separators are polymer films, especially porous polymer films, which are unreactive toward metallic lithium. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, separators may be selected from PET nonwovens filled with inorganic particles. Such separators may have a porosity in the range from 40 to 55%. Suitable pore diameters are, for example, in the range from 80 to 750 nm.

Inventive electrochemical cells further comprise a housing which may have any desired shape, for example cuboidal or the shape of a cylindrical disk. In one variant, the housing used is a metal foil elaborated as a pouch.

Inventive electrochemical cells give a high voltage and are notable for a high energy density and good stability.

Inventive electrochemical cells can be combined with one another, for example in series connection or in parallel connection. Series connection is preferred.

The present invention further provides for the use of inventive electrochemical cells in units, especially in mobile units. Examples of mobile units are motor vehicles, for example automobiles, bicycles, aircraft, or water vehicles such as boats or ships. Other examples of mobile units are those which are moved manually, for example computers, especially laptops, telephones, or power tools, for example from the building sector, especially drills, battery-powered drills or battery-powered tackers.

The use of inventive electrochemical cells in units gives the advantage of a longer run time before recharging. If it were desired to achieve the same run time with electrochemical cells with lower energy density, a higher weight would have to be accepted for electrochemical cells.

The present invention further provides a process for producing electrodes, which comprises

(A) mixing at least one compound of the general formula (I)

LiₐM_{b}F_{c}O_{d} (I)

in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0,
   (B) at least one electrically conductive, carbonaceous material and
   (C) at least one binder
   with one another in one or more steps, and optionally applying them to
   (D) at least one metal foil or polymer film.

Compound of the general formula (I), electrically conductive, carbonaceous material or carbon (B) and binder (C) have already been defined above.

The mixing can be effected in one or more steps.

In one variant of the process according to the invention, compound of the general formula (I), carbon (B) and binder (C) are mixed in one step, for example in a mill, especially in a ball mill. Subsequently, the mixture thus obtainable is applied in a thin layer to a carrier, for example a metal foil or polymer film (D). Before or on incorporation into an electrochemical cell, the carrier can be removed. In other variants, the carrier is retained.

In another variant of the process according to the invention, compound of the general formula (I), carbon (B) and binder (C) are mixed in a plurality of steps, for example in a mill, especially in a ball mill. For example, it is possible first to mix compound of the general formula (I) and carbon (B) with one another. This is followed by mixing with binder (C). Subsequently, the mixture thus obtainable is applied in a thin layer to a carrier, for example a metal foil or polymer film (D). Before or on incorporation into an electrochemical cell, the carrier can be removed. In other variants, the carrier is not removed.

In one variant of the process according to the invention, compound of the general formula (I), carbon (B) and binder (C) are mixed in water or an organic solvent (e.g. N-methylpyrrolidone or acetone). The suspension thus obtainable is applied in a thin layer to a carrier, for example a metal foil or polymer film (D), and the solvent is then removed by a heat treatment. Before or on incorporation into an electrochemical cell, the carrier can be removed. In other variants, the carrier is not removed.

Thin layers in the context of the present invention may, for example, have a thickness in the range from 2 μm up to 250 μm.

To improve mechanical stability, the electrodes can be treated thermally or preferably mechanically, for example pressed or calendered.

In one embodiment of the present invention, a carbonaceous, conductive layer is obtained by obtaining a mixture comprising at least one compound of the general formula (I) and at least one carbonaceous, thermally decomposable compound, and subjecting this mixture to a thermal decomposition.

In one embodiment of the present invention, a carbonaceous, conductive layer is obtained by virtue of the presence, during the synthesis of the compound of the general formula (I), of at least one carbonaceous, thermally decomposable compound, which decomposes to form a carbonaceous, conductive layer on the compound of the general formula (I).

The process according to the invention is very suitable for production of inventive electrode material and electrodes obtainable therefrom.

The present invention further provides composites comprising at least one compound of the general formula (I)

LiₐM_{b}F_{c}O_{d} (I)

in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0, and
   at least one electrically conductive, carbonaceous material, also referred to as carbon (B).

In inventive composites, compound of the general formula (I) has been treated, for example coated, with carbon (B).

In one embodiment of the present invention, in inventive composites, compound of the general formula (I) and carbon (B) are present in a weight ratio in the range from 98:1 to 12:5, preferably 48:1 to 7:2.

Inventive composites are particularly suitable for production of inventive electrode material. A process for production thereof is described above and likewise forms part of the subject matter of the present invention.

The present invention further provides compounds of the general formula (I a),

LiₐM_{b}F_{c}O_{d}* (I a)

in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5, preferably 2.8 to 3.2,
b is in the range from 0.8 to 1.2,
c is in the range from 5.0 to 6.5, preferably 5.8 to 6.2, and
zero <d*≦1.0, for example at least 0.1.

Inventive compounds are particularly suitable for production of inventive composites and for production of inventive electrode materials.

The present invention further provides a process for preparing inventive compounds of the general formula (I a), also referred to as synthesis process according to the invention. The synthesis process according to the invention can be performed in such a way that fluorides of lithium and of metal M are heated with one another, in which case lithium fluoride and/or fluoride are not used in the form of anhydrous fluorides but rather in the form of fluorides which have been stored in a moist environment, for example under ambient air, and may have physically absorbed water.

The invention is illustrated by working examples.

General remark: anhydrous fluorides such as LiF, CrF₃ and VF₃ have been dried at 250° C. under reduced pressure and stored under dry argon in order to exclude moisture.

### Materials Used:

### Electrically Conductive, Carbonaceous Materials:

Carbon (B.1): carbon black, BET surface area of 62 m²/g, commercially available as “Super P Li” from Timcal

Binder (C.1): polyvinylidene fluoride, as pellets, commercially available as Solef® PVDF 1013 from Solvay.

### I. Preparation of Compound of the General Formula I

### I.1 Preparation of β-Li₃VF₆ (Monoclinic Crystal Structure), β-(I.1)

Anhydrous LiF and anhydrous VF₃ were mixed in a molar ratio of 3:1 and introduced into a copper or Monel ampoule. The ampoule was closed and kept in a furnace under an inert gas atmosphere (nitrogen) at a temperature of 900° C. for 14 hours. Subsequently, it was cooled to room temperature. The heating and cooling rates were each 3K/min. β-(I.1) was obtained as a powder.

An X-ray diffractogram of the β-(I.1) thus obtained was recorded, which demonstrated the monoclinic structure of the Li₃VF₆.

### I.2 Preparation of α-Li₃VF₆ (Orthorhombic Crystal Structure), α-(I.2)

Anhydrous LiF and anhydrous VF₃ were mixed in a molar ratio of 3:1 and introduced into a copper or Monel ampoule. The ampoule was closed and kept in a furnace under an inert gas atmosphere (nitrogen) at 780° C. for 2 hours. The heating rate was 3K/min. The ampoule was taken out of the hot furnace and was cooled to room temperature. α-(I.2) was obtained as a powder.

An X-ray diffractogram of the α-(I.2) thus obtained was recorded, which demonstrated the orthorhombic structure of the Li₃VF₆.

### I.3 Preparation of β-Li₃VF₆ (Monoclinic Crystal Structure), β-(I.3)

Anhydrous LiF and anhydrous VF₄ were mixed in a molar ratio of 3:1 and introduced into a copper or Monel ampoule. The ampoule was closed and kept in a furnace under an inert gas atmosphere (nitrogen) at a temperature of 600° C. for 14 hours. Subsequently, it was cooled to room temperature. The heating and cooling rates were each 3K/min. β-(I.3) was obtained in the form of a powder.

An X-ray diffractogram of the β-(I.3) thus obtained was recorded, which demonstrated the monoclinic structure of the Li₃VF₆.

### I.4 Preparation of Li₃CrF₆ (Monoclinic Crystal Structure), β-(I.4)

Anhydrous LiF and anhydrous CrF₃ were mixed in a molar ratio of 3:1 and introduced into a copper or Monel ampoule. The ampoule was closed and kept in a furnace under an inert gas atmosphere (nitrogen) at a temperature of 900° C. for 14 hours. Subsequently, it was cooled to room temperature. The heating and cooling rates were each 3K/min. β-(I.4) was obtained in the form of a powder.

An X-ray diffractogram of the β-(I.4) thus obtained was recorded, which demonstrated the monoclinic structure of the Li₃CrF₆.

### I.5 Preparation of Li₃CrF₆ (Monoclinic Crystal Structure), β-(I.5), by Precipitation

In a Teflon beaker, an aqueous 40% by weight HF solution was added to an aqueous solution of Cr(NO₃)₃.9H₂O (0.32 mol/l) in a molar Cr:F ratio such as 1:6, and then a 0.73 molar Li₂CO₃ solution was added, such that the molar Li:Cr:F ratio was exactly 3:1:6, and the product was heated to 60° C. for 24 hours. The precipitate formed was filtered off, washed with ethanol and dried at 110° C.

An X-ray diffractogram of the β-(I.5) thus obtained was recorded, which demonstrated the monoclinic structure of the Li₃CrF₆.

1.6 Preparation of a lithium vanadium oxide fluoride

LiF and VF₃, each of which had been stored under air for a period of two days and were therefore not anhydrous, were mixed in a molar ratio of 3:1 and introduced into a copper or Monel ampoule. The ampoule was closed and kept in a furnace under an inert gas atmosphere (nitrogen) at a temperature of 900° C. for 14 hours. Subsequently, it was cooled to room temperature. The heating and cooling rates were each 3K/min.

An X-ray diffractogram of the powder thus obtained, β-(I.6), was recorded, which had the monoclinic structure of Li₃VF₆. The oxygen content of the powder was determined to be 1.5 percent by mass. This gives the formula Li₃VF_{5.8}O_{0.2}.

### II. Production of Electrode Materials

II.1 Treatment of Compounds of the General Formula I with Electrically Conductive Carbon

In a stainless steel grinding beaker, compound of the general formula (I) was mixed with 15% by weight of carbon (B.1). This mixture was ground in a ball mill using stainless steel balls for 1 to 24 hours. This gave an inventive composite composed of a compound of the general formula (I) and electrically conductive carbon in the form of a powder.

TABLE 1
Production of carbon black-treated compound of the general formula I

| | Carbon black content, | |
|---|---|---|
| Compound of the formula (I) | % by wt. | Composite |
| β-(I.1) from example I.1 | 15 | C.1 |
| α-(I.2) from example I.2 | 15 | C.2 |

Carbon black contents are based on content of compound of the general formula (I)

II.2 Production of Inventive Electrochemical Cells Using the Example of α-Li₃VF₆-α-(I.2)—from Example I.2

### General Method:

All of the electrode preparation described hereinafter was performed in an inert gas glove box with exclusion of water and oxygen, under argon as protective gas.

48 mg of the powder of α-Li₃VF₆ (orthorhombic crystal structure) from example I.2 were mixed with 6 mg of carbon (B.1) and with 6 mg of (C.1) in an agate mortar, and crushed with a pestle for approximately 10 minutes. This gave a cathode mixture. To produce the electrode, the cathode mixture was pressed onto aluminum meshes (nominal aperture: 0.11 mm, wire diameter: 0.1 mm) (pressure=5 t). The electrodes thus obtainable were then stored at 95° C. in a vacuum drying cabinet over a period of 24 hours. This gave electrodes.

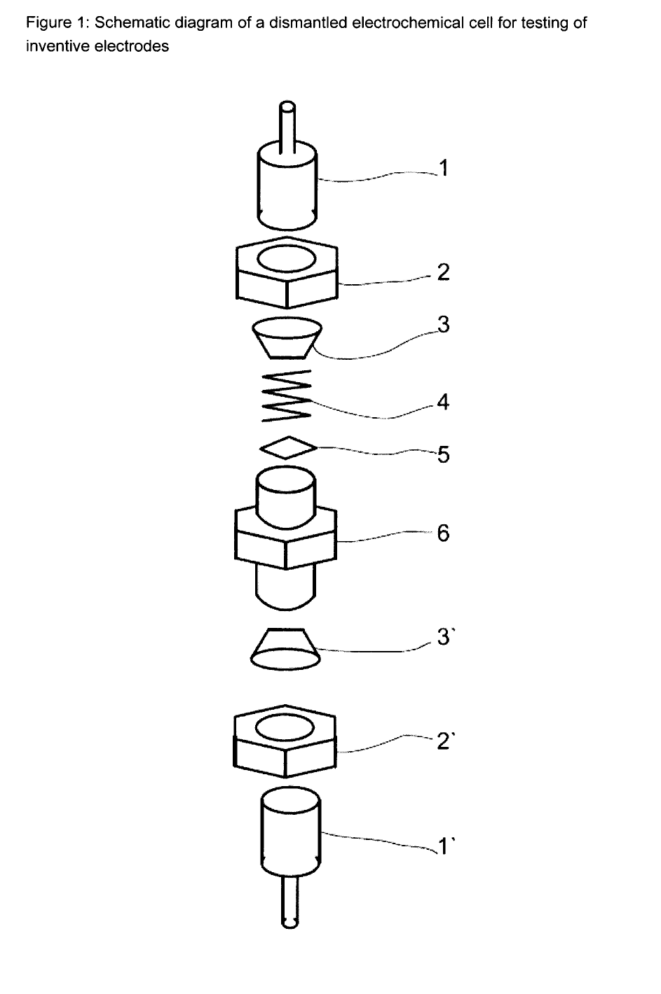

In the assembly of the cell, it was put together from the bottom upward according to the schematic diagram in FIG. 1. In FIG. 1, the anode side is at the top, the cathode side at the bottom.

The labels in FIG. 1 mean:
1, 1′ Dies
2, 2′ Nuts
3, 3′ Sealing ring—two in each case, the second sealing ring in each case, which is somewhat smaller, is not shown here
4 Coil spring
5 Nickel output conductor
6 Housing

The cathode material which has been pressed on to the aluminum mesh and dried was applied to the die on the cathode side 1′. Subsequently, two glass fiber separators, each of thickness 0.5 mm, were placed on to the aluminum mesh. The electrolyte was applied to the separators, and consisted of 1 M LiPF₆ dissolved in ethylene carbonate and dimethyl carbonate in a mass ratio of 1:1. The anode used was a foil of elemental lithium, thickness 0.5 mm, which had been placed on to the impregnated separators. The output conductor 5 used was a nickel plate which was applied directly to the lithium. Subsequently, the seals 3 and 3′ were added, and the parts of the test cell were screwed together. By means of the steel springs in the form of coil springs 4, and by virtue of the pressure generated by the screw connection to the anode die 1, electrical contact was ensured.

This gave inventive electrochemical cells EZ.1.

II.3 Production of Inventive Electrochemical Cells Using the Example of β-Li₃VF₆-β-(I.1)—from Example I.1

The procedure was as described in example 11.2, except using β-Li₃VF₆-β-(I.1)—from example I.1.

This gave inventive electrochemical cells EZ.2.

### III. Characterization of Inventive Electrochemical Cells

The electrochemical characterizations were carried out with a VMP3 potentiostat from Bio-Logic SAS, Claix, France. The inventive electrochemical cells EZ.1 and EZ.2 were equilibrated to 25° C. in a climate-controlled cabinet.

The electrochemical characterization method used was a method known as PITT (potentiostatic intermittent titration technique). In this method, the voltage is not increased at fixed time intervals, but instead the time per potential step is defined via a limiting current I_{Lim}. If the current falls below L_{Lim}, the potential is increased by ΔE. In the case of selection of a sufficiently small limiting current, this measurement principle, in contrast to cyclic voltammetry, allows relatively exact determination of the redox potentials of electrode processes with slow kinetics. The consideration of the amount of charge dq which has flowed per potential step shows, by means of maxima, the potentials at which the oxidation and reduction processes take place. The first charging and discharge operation of two inventive cells EZ.1 and EZ.2 in each case was studied. The potential applied with respect to lithium was varied between 3.0 V and 5.2 V. I_{Lim} was set to 5.25 μA.

For EZ.1 and for EZ.2, electrochemical operation was observed in the region above 4.5 V in the charge cycle. Both materials exhibited reversibility in the first charge cycle. In the discharge cycle, an electrochemical activity with a maximum at 4.4 V is observed for EZ1, and at 4.3 V for EZ.2.

1. An electrode material comprising at least one compound of the general formula (I)
LiₐM_{b}F_{c}O_{d} (I)
in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0.

2. The electrode material according to claim 1, wherein Li may be replaced to an extent of up to 10 mol % by sodium, zinc or magnesium.

3. The electrode material according to claim 1 or 2, wherein the variables are each selected as follows: a=3, b=1, c=6 and d=zero.

4. The electrode material according to any of claims 1 to 3, wherein M is selected from vanadium.

5. The electrode material according to any of claims 1 to 4, wherein compound of the general formula (I) has been treated with at least one electrically conductive, carbonaceous material.

6. An electrode comprising at least one compound of the general formula (I), at least one electrically conductive, carbonaceous material and at least one binder.

7. The electrode according to claim 6, wherein electrically conductive, carbonaceous material is selected from graphite, carbon black, carbon nanotubes, graphene or mixtures of at least two of the aforementioned substances.

8. The use of electrode materials according to any of claims 1 to 5 or of electrodes according to claim 6 or 7 in electrochemical cells.

9. A process for producing electrochemical cells using electrode material according to any of claims 1 to 5 or electrodes according to claim 6 or 7.

10. A process for producing electrodes using electrode material according to any of claims 1 to 5 or electrodes according to claim 6 or 7.

11. An electrochemical cell comprising electrode material according to any of claims 1 to 5 or at least one electrode according to claim 6 or 7.

12. The use of electrochemical cells according to claim 11 as a power source in mobile units.

13. The use of electrochemical cells according to claim 11 or 12, wherein the mobile unit is an automobile, a bicycle, an aircraft, a computer, a telephone or a power tool.

14. A process for producing electrodes, which comprises
(A) mixing at least one compound of the general formula (I)
LiₐM_{b}F_{c}O_{d} (I)
in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0,
(B) at least one electrically conductive, carbonaceous material and
(C) at least one binder
with one another in one or more steps, and optionally applying them to
(D) at least one metal foil or polymer film.

15. A composite comprising at least one compound of the general formula (I)
LiₐM_{b}F_{c}O_{d} (I)
in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
d is in the range from zero to 1.0, and
at least one electrically conductive, carbonaceous material.

16. A compound of the general formula (I a)
LiₐM_{b}F_{c}O_{d} (I a)
in which the variables are each defined as follows:
M is at least one transition metal selected from Ti, Cr, V and Mn, where Ti, Cr, V and Mn may be replaced partially by Al, Ga, Ni, Fe or Co,
a is in the range from 2.5 to 3.5,
b is in the range from 0.8 to 1.2,
c is in the range from 5.0 to 6.5 and
zero <d*≦1.0.
